(19) United States
(12) Patent Application Publication
(10) Pub. No.: US 2026/0116717 A1
(43) Pub. Date: Apr. 30, 2026

(54) LOCKING ELBOW JOINTED AUTOMOTIVE LIFT ARMS

(71) Applicant: BendPak, Inc., Agoura Hills, CA (US)

(72) Inventor: Jeffrey S. Kritzer, Moorpark, CA (US)

(73) Assignee: BendPak, Inc., Agoura Hills, CA (US)

(21) Appl. No.: 19/373,479

(22) Filed: Oct. 29, 2025

Related U.S. Application Data
(60) Provisional application No. 63/714,632, filed on Oct. 31, 2024.

(51) Int. Cl. B66F 7/04; B66F 7/28

(52) U.S. Cl. CPC B66F 7/04; B66F 7/28

(57) ABSTRACT

A lift assembly is configured to lift an automotive component and includes an inner arm section pivotally connected to a carriage, an outer arm section pivotally connected to the inner arm section via an elbow joint secured to the outer arm section, a first lock mechanism configured to prevent pivoting between the outer arm section and the inner arm section when the first lock mechanism is biased in a locked position, and a release member operable to advance the first lock mechanism to a released position to enable pivoting between the outer arm section and the inner arm section. The outer arm section may include a contact member at an outer end thereof to engage the automotive component and lift the automotive component relative to a vehicle that is lifted by a vehicle lift arm assembly.

### CROSS-REFERENCE TO RELATED APPLICATIONS

This application claims the benefit of U.S. Provisional Application No. 63/714,632, filed Oct. 31, 2024, the disclosure of which is hereby incorporated herein in its entirety by reference.

### BACKGROUND OF THE INVENTION

### Field of the Invention

This invention relates to automobile service lifts and, more particularly, to a combination two-post lift for both an electric vehicle and a battery for propelling the vehicle which incorporates locking, elbow jointed, battery lift arms.

### Background & Description of Related Art

A wide variety of post-type automobile lifts have been previously known and used in automobile maintenance and repair to provide access to components on the lower or undersides of vehicles such as tires, brakes, exhaust components, and the like for inspection, repair, and replacement purposes. Post lifts can be in-ground varieties with some components below the floor surface of the shop or above-ground varieties which are mounted on the floor. In-ground post lifts usually have one or two vertically ascending columns mounted below the floor of a service facility, such as a garage, shop, or the like that are raised hydraulically or pneumatically to lift the vehicle. Above-ground post lifts generally have two or four vertical columns or posts, each of which includes a carriage that rides up and down the post. Each of the carriages of a two post lift includes a pair of inwardly extending lift arms with vehicle engagement structure, such as lift pads, at ends thereof that engage lift points or locations on the underside of a body or frame of a vehicle to be lifted. The lift arms are adjusted in length and angular position to engage front and back and left and right lift points of the vehicle.

The vehicle lift arms are typically formed of telescoping sections which are pivotally connected to the lift carriage that is slidably mounted on the post and selectively movable vertically on the post by an actuator, such as a pressurized fluid cylinder connected between the lift carriage and the post. The telescoping lift arm sections enable adjustment of the lengths of the lift arms, and the pivotal connection of the arms to the lift carriage enables adjustment of the angles thereof to allow the lift system to accommodate a variety of vehicle sizes and proportions. The lengths of the lift arms and their angular positions relative to the lift carriage are usually adjusted manually by a mechanic to position the lift pads for engagement with particular lift points of the vehicle. Representative types of such two-post vehicle lift systems are disclosed in U.S. Pat. No. 9,150,395, and U.S. Publication Nos. 2021/0331904 and 2022/0017342, the disclosures of which are incorporated herein in their entirety by reference.

Electrically propelled vehicles, such as automobiles, employ very large rechargeable battery packs to operate propulsion motors. Such vehicles are referred to as electric vehicles (EV's) when propelled solely by a battery or as hybrids if an internal combustion engine is incorporated into the vehicle. Although the batteries for electric vehicles typically have long lives, replacement may eventually be required. Manufacturing defects in the batteries and other circumstances may require earlier replacement. The batteries for electric vehicles may range in weight from about 200 to 500 kilograms (400 to 1200 pounds) or more for passenger vehicles and are usually accessible from beneath the vehicle for replacement. Batteries for full sized electrically propelled pickup trucks, delivery vehicles, and the like are even larger and heavier.

The battery pack or battery of an electric vehicle is typically a large, relatively flat assembly which is secured within a large shallow recess or well on the underside of the vehicle by removable fasteners. The battery is electrically connected to the vehicle electrical motor and systems by separable connectors. For removal, the battery is supported from below while fasteners are removed. The battery is then lowered which enables components of the electrical connectors to separate. The process for installing a new battery reverses the removal process. However, installation of the battery requires precise alignment of components of the mechanical fasteners and electrical connectors prior lifting the battery into the battery recess.

Apparatus and mechanisms have been developed for use with existing two-post lift systems for lifting and lowering an EV battery pack in relation to a vehicle supported by the lift system. Such an EV battery lift is described in U. S. Publication No. US 2022/0402735, the disclosure of which is incorporated herein in its entirety by reference. Such a battery lift may include hydraulic lift actuators, along with a motor, pump, and reservoir for the actuators.

EV battery packs vary in size and shape. Thus, on a two-post lift system in which the vehicle and battery lift arms extend from respective lift carriages supported by the posts, a wide degree of positioning of the battery arms is required. In addition of the pivot joints between the battery lift arms and the battery lift carriages, each arm may also be provided with an “elbow” pivot joint between an inner arm section and an outer arm section.

### SUMMARY OF THE INVENTION

### Summary

The following presents a simplified summary of the invention in order to provide a basic understanding of some aspects of the invention. The summary is not an extensive overview of the invention. It is not intended to identify critical elements of the invention or to delineate the scope of the invention. Its sole purpose is to present some aspects of the invention in a simplified form as a prelude to the more detailed description that is presented elsewhere herein.

The present invention provides embodiments of a two-post lift apparatus which incorporates lift members both for an electric vehicle and the battery for propelling the vehicle which operate in coordination on the two lift posts.

An embodiment of a two-post lift apparatus for lifting and lowering a vehicle and a vehicle component, such as a battery for propelling the vehicle and comprising: first and second lift post assemblies upstanding from a support surface and positioned in laterally spaced relation, each lift post assembly having a primary or vehicle lift track and a secondary or battery lift track extending therealong in spaced apart, parallel relation; each vehicle lift track having a respective primary or vehicle lift carriage positioned therein to enable travel therealong, and each battery lift track having a respective secondary or battery lift carriage positioned therein to enable travel therealong; a vehicle lift actuator assembly engaged between the vehicle lift carriages and the lift post assemblies and operable to enable movement of the vehicle lift carriages along the associated vehicle lift track; a battery lift actuator assembly engaged between the battery lift carriages and the lift post assemblies and operable to enable movement of the battery lift carriages along the associated battery lift track; each vehicle lift carriage having a respective pair of vehicle lift arms or primary lift arms connected thereto to in such a manner as to enable selective engagement thereof with an underside of a vehicle; each battery carriage having a respective pair of battery lift arms or secondary lift arms connected thereto in such a manner as to enable selective engagement thereof with an underside of a battery of a vehicle; and the vehicle lift actuator assembly and the battery lift actuator assembly being controlled in such a manner as to enable selective lifting and lowering of a vehicle and a battery of the vehicle.

In an embodiment of the two post lift apparatus, the vehicle lift actuator assembly may include a respective vehicle lift actuator positioned within each lift post assembly and engaged between the lift post assembly and vehicle lift carriage engaged therewith. The lift apparatus may include an elongated trough member extending between upper ends of the lift post assemblies, and the battery lift actuator assembly may include a battery lift actuator supported by the trough member and engaged with the trough member and each of the battery lift carriages.

In an embodiment of the combination lift apparatus, the primary or vehicle lift tracks are positioned on inward sides of their respective post assemblies in mutually inwardly facing relation, and the secondary or battery lift tracks are positioned on outward sides of their respective post assemblies in mutually outwardly facing relation. Each of the lift arms is pivotally connected to its respective lift carriage; and each of the lift arms is extendible and retractable and has a contact member positioned at an outer end thereof to enable flexible selective positioning of the contact member relative to a load, such as the vehicle or vehicle component, to be lifted thereby. In an embodiment of the combination lift system, the contact member for the battery lift arms may include: an elongated stiffener member extending between outer ends of the battery lift arms; and a pair of battery contact pads positioned on the stiffener member in longitudinally spaced relation thereon.

In an embodiment of the combination lift system, the contact member for the battery lift arms may include a respective battery lift extension upstanding from an end of each battery lift arm; an elongated stiffener member engaged with each battery lift extension; and a pair of battery contact pads positioned on the stiffener member in longitudinally spaced relation thereon. Each battery lift extension may include a swivel member connecting it to its associated battery lift arm to enable rotation of the battery lift extension about a respective vertical axis. The stiffener member may engage each battery lift extension in such a manner as to enable the stiffener member to slide in a longitudinal direction thereof relative to the stiffener member lift extension; and each battery contact pad may be slidable engaged with the associated battery lift extension.

In an embodiment of the combination lift system, an elongated trough member extends between upper ends of the post assemblies, and a battery lift actuator is positioned within the trough member and is engaged with each battery lift carriage in such a manner as to enable coordinated lifting and lowering of the battery lift arms. The battery lift arms may be configured to enable folding thereof to such positions as to enable the vehicle lift arms to be lowered sufficiently for engagement with the underside of a vehicle positioned on the support surface.

In an embodiment of the combination lift system, a contact adapter to engage a load to be lifted may include: a contact receiver positioned at an end of a lift arm of the system; a contact adapter member configured to be removably engaged with the contact receiver; and the contact adapter member having an upper shape which is compatible with a shape of a contact element of the load to be lifted in order to provide substantially non-slip engagement of the contact adapter member with the contact element. A contact spacer may be engaged between the contact adapter member and the contact receiver to position the contact adapter member at a selected height above the lift arm of the lift system.

In an embodiment of a lift system that includes at least one upstanding post, each post has a carriage engaged therewith to move a lift assembly relative to the post, and the lift assembly includes: an inner arm section pivotally connected proximate a first end to the carriage; an outer arm section pivotally connected proximate an inner end to a second end of the inner arm section via an elbow joint that includes at least a first ear connected to a first of either the inner end of the outer arm section or the second end of the inner arm section and the first ear pivotally connected to a second of either the inner end of the outer arm section or the second end of the inner arm section, and the outer arm section having a contact member at an outer end thereof configured to engage a load; a first lock member on the first ear and having a plurality of first locking features extending in an arc; and a second lock member on the second of either the inner end of the outer arm section or the second end of the inner arm section. The second lock member includes a second locking feature advanceable into a locked position in engagement with an aligned one of the first locking features upon pivoting of the outer arm section to a selected pivotal orientation relative to the inner arm section, and engagement of the first locking feature by the second locking feature prevents pivoting of the outer arm section relative to the inner arm section.

In an embodiment of the lift assembly, the second lock member is normally biased into the locked position. The lift assembly may further include a release member operable to advance the second lock member to a released position such that the second locking feature is advanced out of engagement with the aligned one of the first locking features to enable pivoting between the outer arm section and the inner arm section.

In an embodiment of the lift assembly, the first lock member includes an arcuate lock gear and the plurality of first locking features having a plurality of gear teeth, and the second lock member includes a stop block having at least one mating gear tooth. The elbow joint may further include a second ear, and the first and second ears may each be connected to and extend from the inner end of the outer arm section. The arcuate lock gear may be positioned on one of the first ear and the second ear of the outer arm section. A release member may extend through the inner arm section to enable vertical movement relative thereto to advance the stop block secured at an end of the release member to a released position such that the stop block is spaced vertically from the arcuate lock gear. The release member may include a release handle connected thereto to enable manual advancement of the release member to advance the second lock member to the released position.

In an embodiment of the lift assembly, the outer arm section has a secondary outer arm section telescopically positioned therein, and the contact member is positioned thereon.

In an embodiment of the lift assembly, the lift assembly further includes a second lock mechanism engaged between the carriage and the inner arm section such that the second lock mechanism releasably locks the inner arm section at a selected angle relative to the carriage to prevent pivoting of the inner arm section relative to the carriage, and the second lock mechanism is releasable to enable pivoting of the inner arm section relative to the carriage.

In an embodiment of the lift assembly, the inner arm section pivotably connected to the carriage includes a lift clevis connected to the carriage, and the lift clevis may be pivotably connected to a first inner arm section and a second inner arm section.

In an embodiment of a lift system that includes at least one upstanding post, each post has a carriage engaged therewith to move a lift assembly relative to the post, and the lift assembly includes: an inner arm section pivotally connected to the carriage and having upper and lower surfaces; an outer arm section pivotally connected to the inner arm section to form an elbow joint, the elbow joint including an upper ear and a lower ear vertically spaced below the upper ear; a contact member positioned at an outer end of the outer arm section and configured to engage a load; a release shaft extending through the inner arm section to enable vertical reciprocating movement relative thereto between a lower locked position and a raised release position; an arcuate lock gear on the upper ear of the outer arm section and having lock gear teeth formed on at least a portion of the arcuate lock gear; and a geared block positioned at an upper end of the release shaft, the geared block having gear stop teeth formed thereon which mesh with the lock gear teeth of the arcuate lock gear in the lower locked position of the release shaft to prevent pivoting between the outer arm section and the inner arm section and the gear stop teeth are separated from the lock gear teeth in the raised release position of the release shaft.

In an embodiment of the lift assembly, the lift system further includes a resilient member engaged around the release shaft between an abutment thereof and a lower surface of the inner arm section such that the resilient member biases the release shaft in the lower locked position.

In an embodiment of the lift assembly, the outer arm section pivots relative to the inner arm section about a pivot shaft which extends between the upper ear and the lower ear and through an outer end of the inner arm section.

In an embodiment of a lift system that includes at least one upstanding post, the lift system includes a vehicle lift arm assembly configured to support a vehicle thereon that is connected to a vehicle carriage that engages a vehicle track that extends on an inward side of a post to move the vehicle lift arm assembly relative to the post and an automotive component lift assembly. The automotive component lift assembly includes: a lift assembly carriage engaging a lift assembly track of the post that extends on an outward side of the post; first and second inner arm sections pivotably connected to the lift assembly carriage, each of the first and second inner arm sections pivotably connected to an outer arm section and an elbow joint is formed between each outer arm section and the inner arm section connected thereto; a contact member positioned at an outer end of each outer arm section and configured to engage an automotive component; a first lock mechanism having a lock gear secured to each elbow joint and formed with a convex surface that compliments a concave surface of a geared block positioned adjacent each elbow joint such that the geared block is moveable relative to the lock gear between a locked position that is in engagement with the lock gear and a released position that is disengaged from the lock gear; and a second lock mechanism pivotably connecting each inner arm section to the lift assembly carriage such that the second lock mechanism releasably locks the inner arm section at a selected angle relative to the lift assembly carriage to prevent pivoting of the inner arm section relative to the lift assembly carriage and is releasable to enable pivoting of the inner arm section relative to the lift assembly carriage. In an embodiment of the lift assembly, the automotive component lift assembly is movable relative to the post independent of the vehicle lift arm assembly.

In an embodiment of the automotive component lift assembly, each geared block is secured to a release shaft extending through one of the inner arm section and the outer arm section to enable movement of the geared block secured thereto. The release shaft may include a resilient member engaged between the release shaft and the arm section engaged thereby to resiliently bias the first lock mechanism to position the geared block in the locked position.

Various objects and advantages of the present invention will become apparent from the following description taken in conjunction with the accompanying drawings wherein are set forth, by way of illustration and example, certain embodiments of this invention. The drawings constitute a part of this specification, include exemplary embodiments of the present invention, and illustrate various objects and features thereof.

### BRIEF DESCRIPTION OF THE DRAWINGS

Embodiments of the invention are described in detail below with reference to the attached drawing figures.

FIG. 1 is a perspective view of a two-post vehicle and battery lift system embodying the present invention.

FIG. 2 is an enlarged bottom plan view of the lift system supporting an electric vehicle and a battery for propelling the vehicle.

FIG. 3 is a perspective view of the lift system shown supporting a battery of an electric vehicle.

FIG. 4 is a further enlarged perspective view a battery lift assembly of the lift apparatus.

FIG. 5 is a further enlarged fragmentary perspective view of one end of a stiffener link and battery contact pad of the battery lift assembly.

FIG. 6 is a fragmentary exploded perspective view of a vehicle lift arm along with a contact pad and an adapter for the contact pad.

FIG. 7 is a view similar to FIG. 6 and illustrates several alternative embodiments of contact pad adapters for a vehicle lift arm of the lift system.

FIG. 8 is a fragmentary perspective view of a cross-over trough member of the lift system, including an actuator for the battery lift assemblies.

FIG. 9 is a perspective view of an embodiment of a combination vehicle and battery lift which incorporates the locking, elbow jointed, battery lift arms according to the present invention.

FIG. 10 is an enlarged fragmentary perspective view of a battery lift assembly according to the present invention.

FIG. 11 is a greatly enlarged fragmentary perspective view of an elbow joint according to the present invention and components of an elbow joint lock, shown in a locking position.

FIG. 12 is a further enlarged fragmentary perspective view of locking elements of the elbow joint lock shown in a released condition.

The drawing figures do not limit the invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

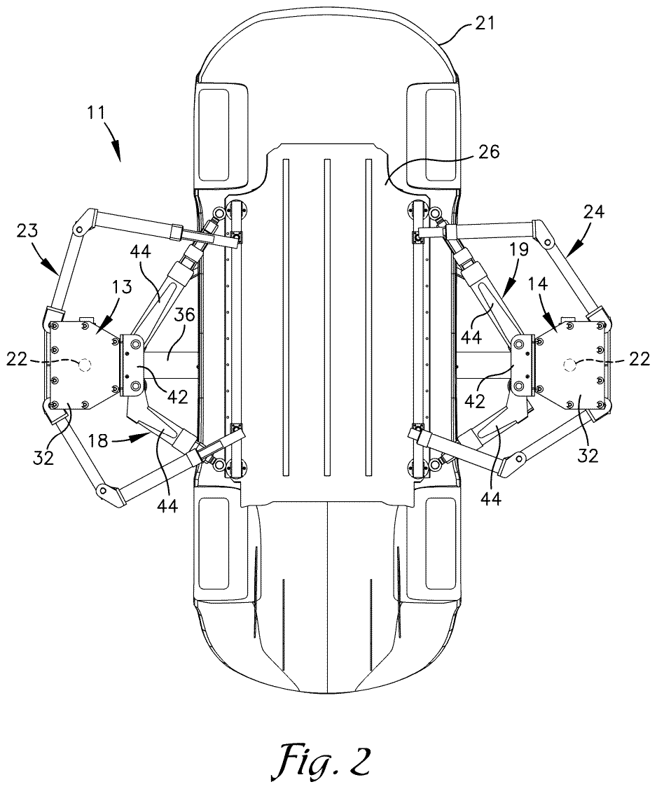

Referring to the drawings in more detail, the reference number 11 generally designates an embodiment of a combination two-post lift apparatus according to the present invention. In general, the two-post lift apparatus 11 includes an elongated right post assembly 13 and an elongated left post assembly 14 upstanding in laterally spaced relation from a support surface 16. The left and right post assemblies may also be referred to as first and second lift post assemblies. A right vehicle lift assembly 18 is slidably engaged with the right post assembly 13, and a left vehicle lift assembly 19 is slidably engaged with the left post assembly 14. The vehicle lift assemblies 18 and 19 are operated in coordination to lift and lower a vehicle, such as an electric vehicle or EV 21 (FIG. 2), with respect to the surface 16.

Additionally, a right battery lift assembly 23 is slidably engaged with the right post assembly 13, and a left battery lift assembly 24 is slidably engaged with the left post assembly 14. The battery lift assemblies 23 and 24 are operated in mutual coordination, and in coordination with the vehicle lift assemblies 18 and 19, to lift and lower a battery pack or battery 26 (FIG. 2) with respect to the vehicle 21. The vehicle lift assemblies may also be referred to as primary lift assemblies and the battery lift assemblies may also be referred to as secondary lift assemblies or vehicle component lift assemblies. In one embodiment, the battery 26 is a battery adapted to provide sufficient power to propel the vehicle.

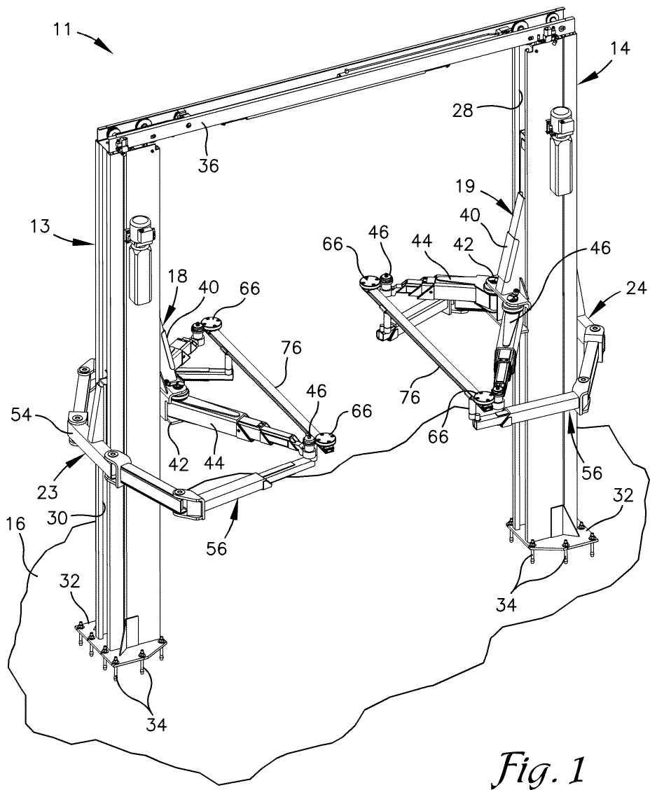

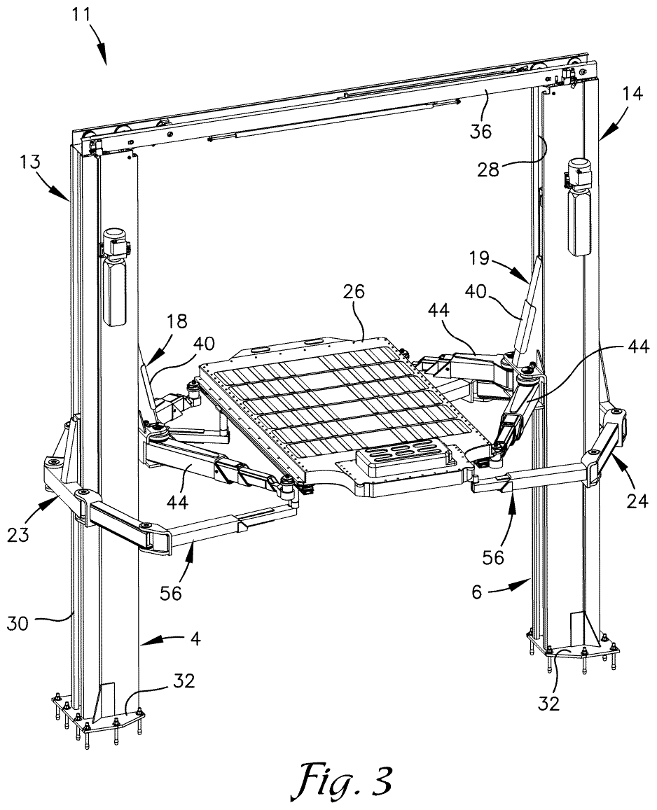

It should be noted that the directional references employed in FIGS. 1-3 are made with respect to the vehicle 21 such that the right and left sides of the apparatus 11 and the vehicle 21 are opposite to the right and left sides of FIGS. 1-3, as viewed.

Each of the illustrated post assemblies 13 and 14 includes a primary lift track or vehicle lift guide 28 extending along an inward side thereof and a secondary lift track or battery lift guide 30 extending along an outward side thereof in parallel relation to the primary lift track 28. Each of the post assemblies 13 and 14 may be formed by a pair of elongated members having a squared C-shape cross section with closed sides joined in back to back relation. Open sides of the post assemblies 13 and 14 form the guides or tracks 28 and 30 with the vehicle lift tracks 28 extending in mutually inward facing relation and the battery lift tracks 30 extending in mutually outward facing relation. Each of the post assemblies 13 and 14 has a base plate 32 through which fasteners, such as bolts 34 pass. The bolts 34 may be embedded in the floor forming the support surface 16, such as a vehicle repair facility floor. Upper ends of the post assemblies 13 and 14 are structurally joined by a trough member 36 through which control conductors, lift cables, and the like may extend.

Each of the illustrated vehicle lift assemblies 18 and 19 includes a primary or vehicle lift carriage 40 which is slidably supported within a respective vehicle lift guide 28 to enable vertical movement therealong. At a lower end of each vehicle lift carriage 40, a vehicle lift clevis 42 is provided which has inner ends of a pair of primary or vehicle lift arm assemblies or arms 44 pivotally connected thereto. Each vehicle lift arm assembly 44 has extendible and retractable, telescoping sections which enable the length of the arm assembly to be selectively adjusted. The illustrated vehicle lift carriage 40 may incorporate a releasable means (not shown) of preventing free pivoting of the arm assemblies relative to the clevis 42 for safety purposes.

A vehicle contact member 46 is supported at the outer end of each vehicle lift arm 44 for engagement with a lift point of the vehicle 21 to thereby support the load of the vehicle as the vehicle is lifted and lower relative to the support surface. Pivoting and extension or retraction of the vehicle lift arms 44 allows the lift arms 44 to be selectively positionable relative to the vehicle to position the contact members 46 in position to support a portion of the load of the vehicle.

The lift assemblies 18 and 19 may be raised and lowered simultaneously by means of respective primary actuator assemblies or linear actuators, such as hydraulic cylinders 22 (see FIG. 2), connected between post assemblies 13 and 14 respectively and the vehicle lift assemblies 18 and 19. Further details of the vehicle lift assemblies 18 and 19 may be found in U. S. Publication 2021/0331904, previously referenced, the disclosure of which is incorporated herein by reference.

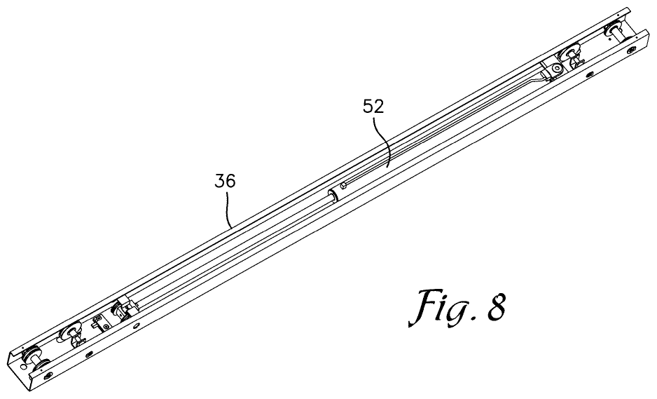

Referring to FIGS. 1-4, the illustrated battery lift assemblies 23 and 24 are substantially similar, and each includes a secondary or battery lift carriage 50 which is slidably positioned within the battery lift guide 30 of the associated post assembly 13 or 14. The battery lift carriages 50 are raised and lowered by a secondary or battery lift actuator 52 (FIG. 8) which, in the illustrated embodiment, is positioned within the trough 36 and engaged with the carriages by means of battery lift cables (not shown) routed therebetween to enable simultaneous lifting and lowering of the carriages 50. The battery lift actuator 52 and battery lift cables comprise an embodiment of a secondary or battery lift actuator assembly. It is foreseen that separate hydraulic actuators may be connected between each battery lift carriage 50 and the respective lift post assemblies 13 and 14. It is foreseen that some type of ratchet arrangement (not shown) may be engaged between the battery lift carriages 50 and the post assemblies 13 and 14 to limit the descent of the battery 26 in the event of loss of hydraulic pressure by the battery lift actuator 52.

Referring particularly to FIG. 4, each lift carriage 50 includes a lower cross member 54 extending horizontally thereacross. At each end of the cross member 54, a battery lift arm assembly 56 is connected thereto to enable pivoting about a substantially vertical axis. Each of the illustrated battery lift arm assemblies 56 includes an upper arm member 58, which is pivotally connected to the cross member 54, and a telescoping forearm member 60 which is pivotally connected to the upper arm member 58. The terms “upper arm” and “forearm” describing the arm members 58 and 60 are analogous to human anatomical terms. The forearm 60 is formed by an outer arm section 62 which is connected to the cross member 54 via the upper arm member 58 and an inner arm section 64 which telescopes into the outer arm section 62.

The inner arm sections 64 may have battery contact pads 66 which may be supported directly on outer ends thereof. In the illustrated battery lift assemblies 23 and 24, the outer ends 68 have battery lift pad extensions 72 upstanding therefrom. The battery lift pad extensions 72 are connected to the outer ends 68 of the arm sections 64 by swivel members 73 which are pivotally connected to the lift pad extensions 72 and to the outer ends 68 of the arm sections 64. The swivel members 73 shown include a cylindrical receiver 74 with a pin or shaft 75 connected to and depending from one side of the receiver 74. A lower end of the lift pad extension 72 is received within the receiver 74, and the pin 75 of the swivel member 73 is received within an opening or receiver (not shown) formed in the distal end of the inner arm section 64 of each battery lift arm assembly 56.

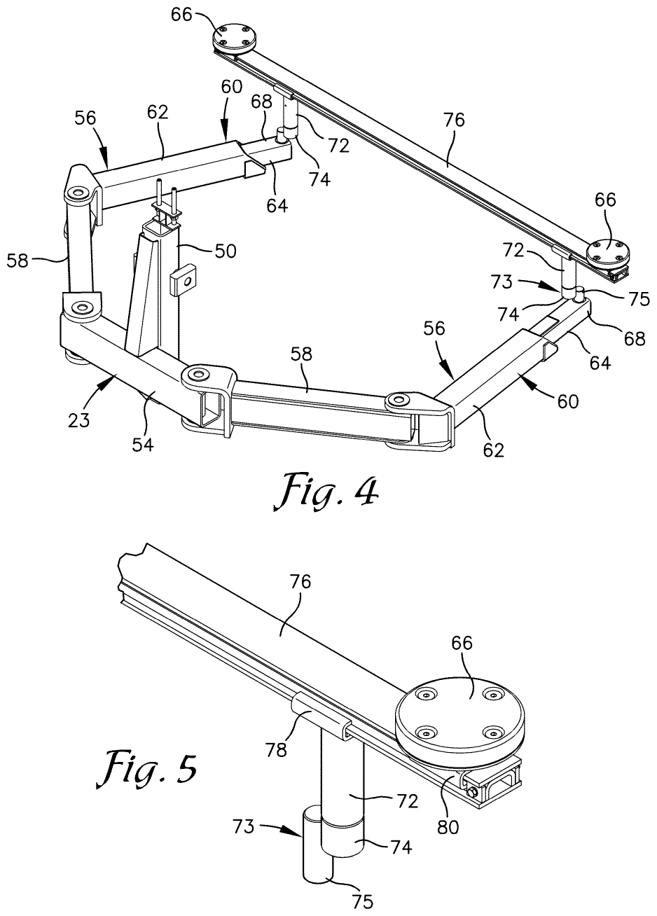

An elongated stiffener member or beam 76 extends between upper ends of the lift pad extensions 72 of each of the battery lift assemblies 23 and 24. In the illustrated battery lift assemblies, the stiffener beam 76 slidably engages extension slide brackets or slides 78 (FIG. 5) positioned at the upper end of each of the lift pad extensions 72. The battery contact pads 66 are supported on the stiffener beam 76 in longitudinally spaced relation thereon by means of battery contact pad side brackets or slides 80. The pivotability of the battery lift arm assemblies 56, the telescoping nature of the forearm members 60, the swivels 74, and the slide brackets 78 and 80 provide a considerable degree of adjustability of the position of the battery contact pads 66 for accurate placement thereof in relation to the battery 26. The stiffener beams 76 provide a degree of rigidness to the battery lift assemblies 23 and 24, when supporting the battery 26, to reduce tendencies to flex the battery.

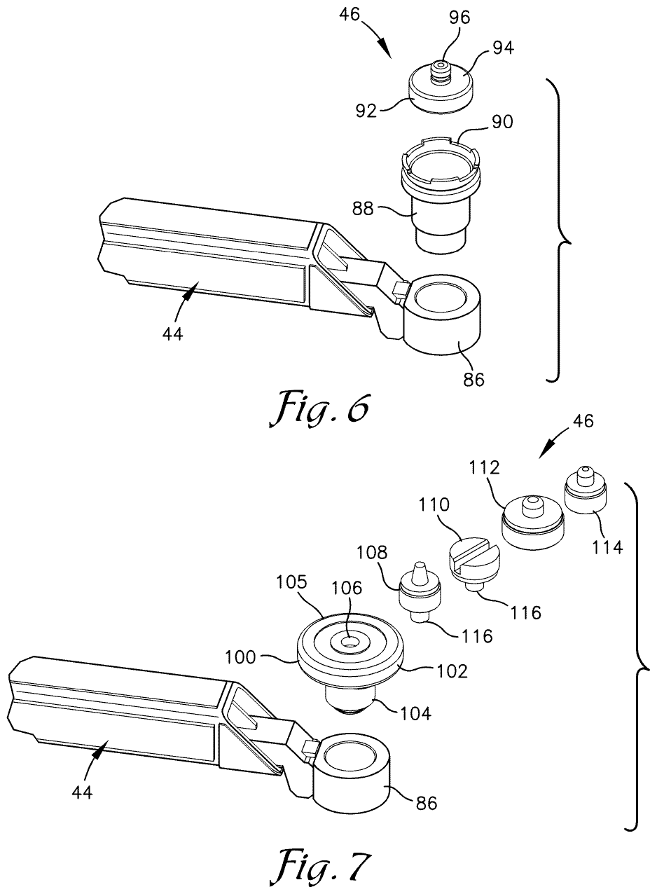

Referring to FIG. 6, the illustrated vehicle contact member or contact adapter 46 may be supported a contact receiver 86 positioned at an end of one of the vehicle lift arm assemblies 44 by a vertical spacer 88 positioned in the receiver 86 and having a dish adapter 90 secured to the top of the spacer 88. A contact pad member 92 is removably positioned on the dish adapter 90 and includes a padding material 94 thereon, such as a hard rubber. The pad member 92 may have an upper shape which may comprise an upstanding center protrusion 96 which is compatible in shape with or mates with a shape of a contact element or lift point fixture (not shown) provided on the underside of the vehicle 21 to provide non-slip engagement therebetween for safe lifting and lowering of the vehicle.

FIG. 7 illustrates modified embodiments of a vehicle contact member 46 including a vehicle contact member 100. The contact member 100 includes an upper contact pad 102 having a mounting shaft 104 depending therefrom. The shaft 104 is sized to be positioned in the contact receiver 86 and may have such a length as to position the body of the vehicle 21 at a specific height above the lift arm assembly 44. The contact pad 102 may be covered by a padding material 105, such as a hard rubber. The contact pad 102 may be provided with a centered aperture 106 to receive an additional adapter, such as a selected one of the contact adapters 108, 110, 112, or 114 having varied geometries to mate with different features on the underside of the vehicle 21. It is foreseen that adapters having additional alternative configurations can be provided for use with the contact receiver 86 and pad member 100. Each adapter 108, 110, 112, or 114 preferably includes a depending stem 116 for reception within the centered aperture 106 of the contact pad 102. The stem 116 is sized relative to the centered aperture 106 to permit rotation of the associated adapter 108, 110, 112, or 114 relative to the contact pad 102 to permit proper alignment of the adapter 108, 110, 112, or 114 with the mating feature on the vehicle 21.

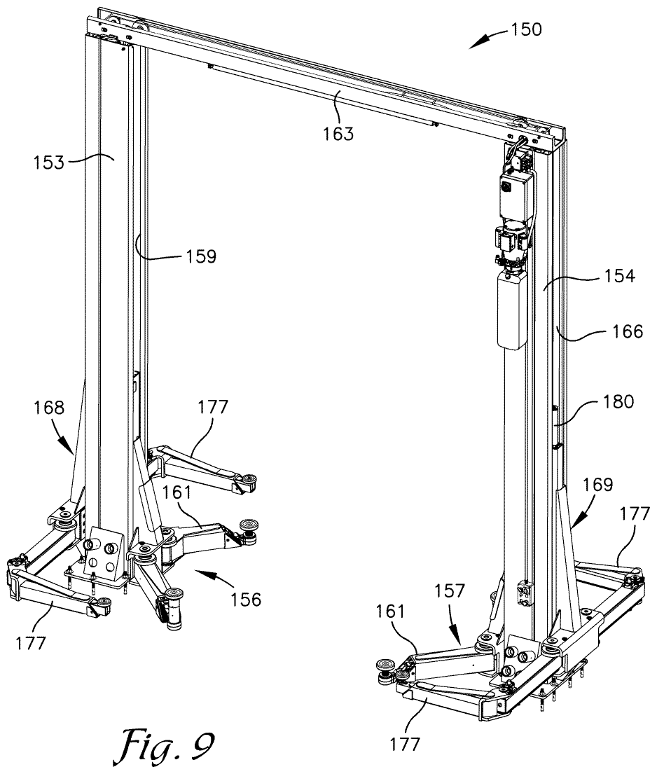

FIG. 9 illustrates a modified embodiment of a lift apparatus 150 which is similar in many respects to the lift apparatus 11 described above. The lift apparatus 150 includes left and right upstanding lift post assemblies 153 and 154 which support left and right vehicle lift assemblies 156 and 157 in inwardly facing vehicle lift guides 159. The vehicle lift assemblies 156 and 157 may be substantially similar to the vehicle lift assemblies 18 and 19 illustrated in FIGS. 1-3. Each of the vehicle lift assemblies 156 and 157 includes a pair of extendible vehicle lift arms 161 pivotally connected thereto. The vehicle lift assemblies 156 and 157 may be raised or lowered by operation of a vehicle lift actuator, similar to the actuator 22 illustrated diagrammatically in FIG. 2. Upper ends of the illustrated posts 153 and 154 are connected by a trough member 163, which may be substantially similar to the trough member 36 (FIG. 1).

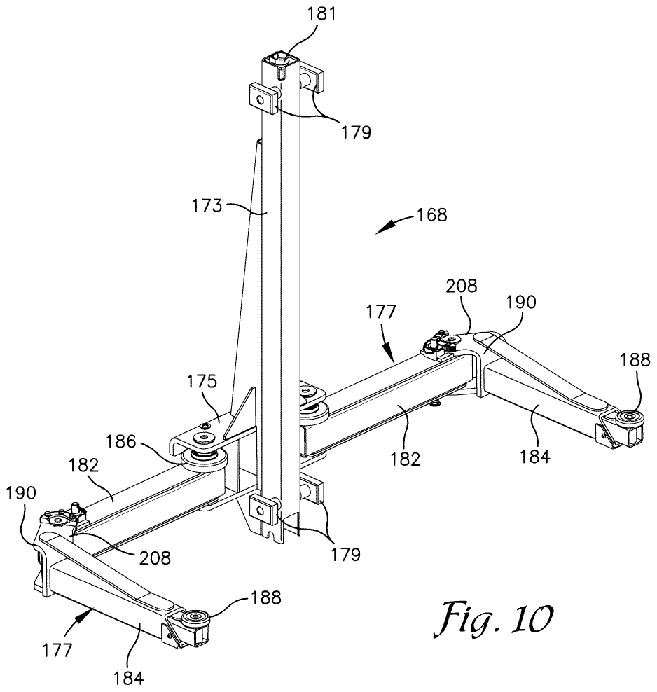

The lift posts 153 and 154 include elongated, outwardly facing battery lift guides 166 which support left and right battery lift assemblies 168 and 169 to enable movement therealong. FIG. 10 illustrates the left battery lift assembly 168, and the right battery lift assembly 169 is substantially similar to the left assembly 168. The illustrated battery lift assembly 168 includes a battery lift carriage 173 having a double-ended battery lift clevis 175 joined thereto at a lower end thereof. The clevis 175 has a pair of battery lift arm assemblies 177 pivotally connected thereto, which may include a front and a rear battery lift arm assembly 177. The battery lift carriage 173 may have upper and lower slide bearing members 179 positioned thereon to facilitate movement of the carriage 173 along the battery lift guides 166 of the post assemblies 153 and 154. The battery lift carriages 173 may be lifted and lowered by action of a battery lift actuator 180 (FIG. 9), or a pair of such battery lift actuators 180 operated in coordination, which are located within the lift post assemblies 153 and 154. The battery lift carriage 173 may include an opening surrounded by a collar 181 (FIG. 10) at an upper end thereof through which a portion of the battery lift actuator 180 may extend.

Referring to FIG. 10, each of the battery lift arm assemblies 177 includes an inner arm section 182 and an outer arm section 184 pivotally connected thereto. Each inner arm section 182 is pivotally connected to the battery lift clevis 175 and includes a lift arm rotational lock mechanism 186 to enable the inner arm section 182 to be releasably locked at a selected pivot angle relative to the clevis 175. Such a rotational lock mechanism can be configured similar to that which is disclosed in U.S. Publication No. 2021/0331904, previously referenced above. Each outer arm section 184 may have a battery contact pad 188 positioned at the end thereof.

Each outer arm section 184 is pivotally connected to its respective inner arm section 182 by a lift arm elbow clevis or hinging joint 190. Referring to FIG. 11, the illustrated elbow clevis 190 includes an inverted L-shaped upper ear 192 and a lower ear 194 spaced apart therefrom and joined to a depending outer end wall 196 of the upper ear 192. In an embodiment, the upper ear 192 and the lower ear 194 are integrally formed. The clevis 190 is sized so that the upper ear 192 engages an upper surface 198 of the inner arm section 182 and the lower ear 194 engages a lower surface 200 of the inner arm section 182. The outer arm section 184 is joined to the depending wall 196 of the clevis 190. The outer arm section 184 may include a brace 202 which extends between the upper ear 192 and an upper surface of the outer arm section 184 to reinforce the outer arm section 194. The clevis 190 is pivotally connected to an outer end 204 of the inner arm section 182 by a pivot shaft 206 which extends between the upper ear 192 and the lower ear 194 and passes through the outer end 204 of the inner arm section 182. The clevis 190 and pivot shaft 206 form components of an elbow joint 208 between the inner arm section 182 and the outer arm section 184.

The battery lift assemblies 23 and 24 described above (FIGS. 1 and 4) employ the stiffener beam 76 to maintain some degree when supporting a vehicle battery 26. The battery lift assemblies 168 and 169 are believed to provide an improved degree of rigidity of the battery lift assemblies 168 and 169 by the use of the rotation lock mechanisms 186 between the battery lift clevis 175 and the inner arm sections 182 and with elbow lock mechanisms 212 engaged between the inner battery lift arm sections 182 and the outer battery lift arm sections 184 at the elbow joints 208 thereof.

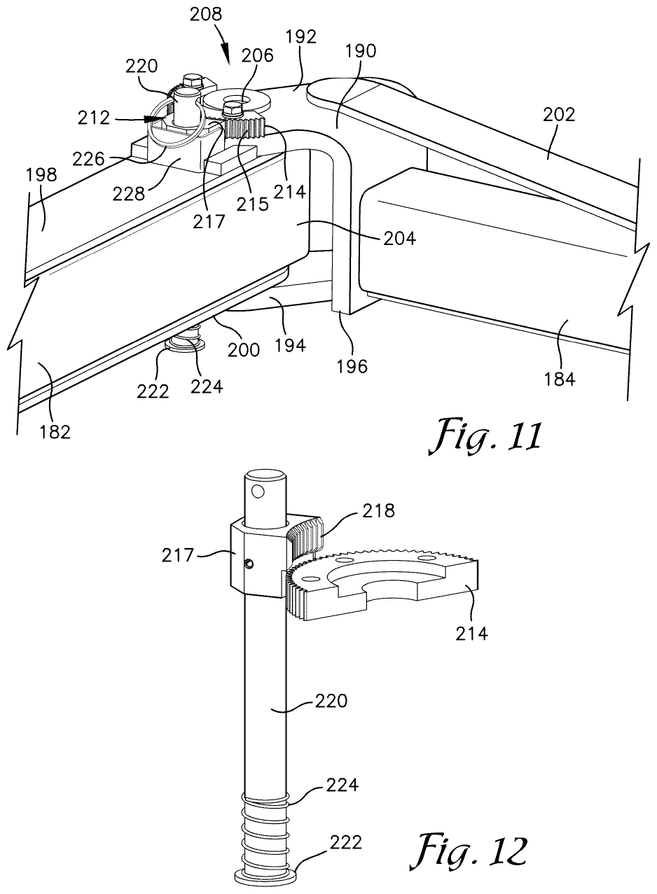

Referring to FIGS. 11 and 12, the illustrated elbow joint lock mechanisms 212 include a sector or lock gear 214 having gear lock teeth 215 on a convex surface thereof and a gear stop block or geared block 217 having gear stop teeth formed on a concave surface thereof along a side of the gear stop block 217 adjacent the lock gear 214. The illustrated lock gear 214 is semicircular or has a convex surface that compliments the concave surface of the gear stop block 217 and is secured to an upper surface of the upper ear 192 of the elbow clevis 190. In embodiment, lock gear 214 forms an arc or circumference with the pivot shaft 206 forming a center thereof that is a point equidistant from all points of the convex surface of the lock gear 214. The gear stop block 217 is secured to a gear lock shaft 220, near an upper end thereof and adjacent the gear stop block 217. The gear lock shaft 220 extends vertically through the outer end 204 of the inner arm section 182 to enable reciprocating or lateral movement therethrough and pivoting movement of the gear lock shaft 220. The shaft 220 is retained on the inner arm section 182 by engagement of the gear stop block 217 with the upper surface of the inner arm section 182 and a spring abutment 222 secured to a lower end of the gear lock shaft 220 and a gear lock spring 224 positioned between the spring abutment 222 and a lower surface 200 of the inner arm section 282.

The gear lock spring 224 is a compression spring and biases or urges the shaft 220 to a lower lock position shown in FIG. 11 with gear stop teeth 218 of the stop block 217 meshing with the gear lock teeth 215 of the elbow lock gear 214. The lock position shaft 220 and block 217 prevents relative pivoting of the outer arm section 184 relative to the inner arm section 182. As best shown in FIG. 12, the stop block 217 can be lifted to disengage the gear lock teeth 215 from the gear stop teeth 218 by the use of a lift ring or a release handle 226, or a similar component, positioned at the upper end of the gear lock shaft 220 to lift the gear lock shaft 220 and the gear stop block 217 above the lock gear 214 to enable relative pivoting of the lock gear 214 and of the outer arm section 184 relative to the inner arm section 182. The gear lock shaft 220 may also be referred to as a release member or release shaft. The elbow lock mechanism 212 may include a gear stop block guide 228 within which the gear stop block 217 reciprocates.

It is to be understood that while certain forms of the present invention have been illustrated and described herein, it is not to be limited to the specific forms or arrangement of parts described and shown.

What is claimed and desired to be secured by Letters Patent is:

1. A lift system that includes at least one upstanding post, each post having a carriage engaged therewith to move a lift assembly relative to the post, the lift assembly comprising:
an inner arm section pivotally connected proximate a first end to the carriage;
an outer arm section pivotally connected proximate an inner end to a second end of the inner arm section via an elbow joint, the elbow joint comprising at least a first ear connected to a first of either the inner end of the outer arm section or the second end of the inner arm section and the first ear pivotally connected to a second of either the inner end of the outer arm section or the second end of the inner arm section, the outer arm section having a contact member at an outer end thereof configured to engage a load;
a first lock member on the first ear and having a plurality of first locking features extending in an arc; and
a second lock member on the second of either the inner end of the outer arm section or the second end of the inner arm section, the second lock member having a second locking feature advanceable into a locked position in engagement with an aligned one of the first locking features upon pivoting of the outer arm section to a selected pivotal orientation relative to the inner arm section, engagement of the first locking feature by the second locking feature preventing pivoting of the outer arm section relative to the inner arm section.

2. The lift assembly as in claim 1 wherein the second lock member is normally biased into the locked position.

3. The lift assembly as in claim 2 further comprising a release member operable to advance the second lock member to a released position wherein the second locking feature is advanced out of engagement with the aligned one of the first locking features to enable pivoting between the outer arm section and the inner arm section.

4. The lift assembly of claim 1, wherein:
the first lock member comprises an arcuate lock gear and the plurality of first locking features having a plurality of gear teeth, and
the second lock member comprises a stop block having at least one mating gear tooth.

5. The lift assembly of claim 4, wherein:
the elbow joint further comprises a second ear, and the first and second ears are each connected to and extend from the inner end of the outer arm section,
the arcuate lock gear is positioned on one of the first ear and the second ear of the outer arm section, and
a release member extends through the inner arm section to enable vertical movement relative thereto to advance the stop block secured at an end of the release member to a released position, wherein the stop block is spaced vertically from the arcuate lock gear.

6. The lift assembly of claim 5, wherein the release member comprises a release handle connected thereto to enable manual advancement of the release member to advance the second lock member to the released position.

7. The lift assembly of claim 1, wherein the outer arm section has a secondary outer arm section telescopically positioned therein, and the contact member is positioned thereon.

8. The lift assembly of claim 1, further comprising a second lock mechanism engaged between the carriage and the inner arm section, wherein the second lock mechanism releasably locks the inner arm section at a selected angle relative to the carriage to prevent pivoting of the inner arm section relative to the carriage, and the second lock mechanism is releasable to enable pivoting of the inner arm section relative to the carriage.

9. The lift assembly of claim 1, wherein the inner arm section pivotably connected to the carriage includes a lift clevis connected to the carriage, and the lift clevis is pivotably connected to a first inner arm section and a second inner arm section.

10. A lift system that includes at least one upstanding post, each post having a carriage engaged therewith to move a lift assembly relative to the post, the lift assembly comprising:
an inner arm section pivotally connected to the carriage and having upper and lower surfaces;
an outer arm section pivotally connected to the inner arm section to form an elbow joint, the elbow joint including an upper ear and a lower ear vertically spaced below the upper ear;
a contact member positioned at an outer end of the outer arm section and configured to engage a load;
a release shaft extending through the inner arm section to enable vertical reciprocating movement relative thereto between a lower locked position and a raised release position;
an arcuate lock gear on the upper ear of the outer arm section and having lock gear teeth formed on at least a portion of the arcuate lock gear;
a geared block positioned at an upper end of the release shaft, the geared block having gear stop teeth formed thereon which mesh with the lock gear teeth of the arcuate lock gear in the lower locked position of the release shaft to prevent pivoting between the outer arm section and the inner arm section; wherein:
the gear stop teeth are separated from the lock gear teeth in the raised release position of the release shaft.

11. The lift assembly of claim 10, further comprising a resilient member engaged around the release shaft between an abutment thereof and a lower surface of the inner arm section, the resilient member biasing the release shaft in the lower locked position.

12. The lift assembly of claim 10, wherein the release shaft comprises a release handle connected thereto to enable manual retraction of the release shaft to the raised release position.

13. The lift assembly of claim 10, wherein the outer arm section pivots relative to the inner arm section about a pivot shaft which extends between the upper ear and the lower ear and through an outer end of the inner arm section.

14. The lift assembly of claim 10, wherein the outer arm section has a secondary outer arm section telescopically positioned therein, and the contact member is positioned thereon.

15. The lift assembly of claim 10, further comprising a second lock mechanism engaged between the carriage and the inner arm section which releasably locks the inner arm section at a selected angle relative to the carriage to prevent pivoting of the inner arm section relative to the carriage and which is releasable to enable pivoting of the inner arm section relative to the carriage.

16. The lift assembly of claim 10, wherein the inner arm section pivotably connected to the carriage includes a lift clevis connected to the carriage, and the lift clevis is pivotably connected to first and second inner arm sections.

17. A lift system that includes at least one upstanding post, the lift system including a vehicle lift arm assembly configured to support a vehicle thereon that is connected to a vehicle carriage that engages a vehicle track that extends on an inward side of a post to move the vehicle lift arm assembly relative to the post and an automotive component lift assembly, the automotive component lift assembly comprising:
a lift assembly carriage engaging a lift assembly track of the post that extends on an outward side of the post;
first and second inner arm sections pivotably connected to the lift assembly carriage, wherein each of the first and second inner arm sections are pivotably connected to an outer arm section, and an elbow joint is formed between each outer arm section and the inner arm section connected thereto;
a contact member positioned at an outer end of each outer arm section and configured to engage an automotive component;
a first lock mechanism having a lock gear secured to each elbow joint and formed with a convex surface that compliments a concave surface of a geared block positioned adjacent each elbow joint, wherein the geared block is moveable relative to the lock gear between a locked position that is in engagement with the lock gear and a released position that is disengaged from the lock gear;
a second lock mechanism pivotably connecting each inner arm section to the lift assembly carriage, wherein the second lock mechanism releasably locks the inner arm section at a selected angle relative to the lift assembly carriage to prevent pivoting of the inner arm section relative to the lift assembly carriage and is releasable to enable pivoting of the inner arm section relative to the lift assembly carriage; wherein:
the automotive component lift assembly is movable relative to the post independent of the vehicle lift arm assembly.

18. The automotive component lift assembly of claim 17, wherein each geared block is secured to a release shaft extending through one of the inner arm section and the outer arm section to enable movement of the geared block secured thereto.

19. The automotive component lift assembly of claim 18, wherein the release shaft comprises a resilient member engaged between the release shaft and the arm section engaged thereby to resiliently bias the first lock mechanism to position the geared block in the locked position.

20. The automotive component lift assembly of claim 17, wherein each outer arm section has a secondary outer arm section telescopically positioned therein, and the contact member is positioned thereon.

21. The automotive component lift assembly of claim 17, further comprising an upper ear and a lower ear that extend from each outer arm section and engage the inner arm section connected thereto, wherein the outer arm section is pivotable relative to the inner arm section about a pivot shaft which extends between the upper ear and the lower ear and through an outer end of the inner arm section.
